(19) United States
(12) Patent Application Publication
(10) Pub. No.: US 2008/0115608 A1
(43) Pub. Date: May 22, 2008

(54) HIGH SPEED/HIGH POWER RE-SETTABLE MECHANICAL DISCONNECT

(75) Inventors: BALWINDER S. BIRDI, TUCSON, AZ (US); WILLIAM M. SCHERZINGER, TUCSON, AZ (US); BO HAN, NAZARETH, PA (US); BEN POWELL, HOUSTON, TX (US); JEREMY CARROLL, TUCSON, AZ (US); GARY BARTLETT, TUCSON, AZ (US); NATHEN HATCH, TAYLOR, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/562,324

(22) Filed: Nov. 21, 2006

(51) Int. Cl. F16H 57/00

(52) U.S. Cl. 74/405

(57) ABSTRACT

A re-settable mechanical disconnect includes a fixed flange and a retracting flange, each including a plurality of ramped teeth that mate together. The incline of the ramp of each tooth may allow power to be transmitted from the engine to the generator at required speeds and may aid disengagement of the retracting flange form the fixed flange. The mechanical disconnect may be activated in the case of a generator failure and may be re-set and reused once the cause for activation is cleared. An actuator assembly may provide an external force in axial direction that may initiate disengagement and re-engagement of the retracting flange and the fixed flange. The mechanical disconnect may be suitable for, but not limited to, applications in the aircraft and aerospace industries, for example, for disengaging a variable frequency generator from an engine in the case of generator failure thus preventing damage to the gearbox.

### BACKGROUND OF THE INVENTION

The present invention generally relates to aircraft engines and electric generators and, more particularly, to a re-settable mechanical coupling and a method for transmission and interruption of power between an aircraft engine and an electric generator.

An aircraft uses an engine for thrust and generator for electrical power generation. Aircraft typically generate their own electricity utilizing the auxiliary power from engines. The engines have a power take off shaft that goes through a gearbox and where it is connected with a drive shaft of an electric generator to produce electricity for the aircraft. If the generator fails in flight but continues to rotate after failure occurs, damage could be caused to the generator, to the engine, or both. This may then lead to further damage of the aircraft.

In the event of malfunction or sudden jamming of the generator, for example, if the oil temperature in an electric generator suddenly rises to the limiting value or the rate of the rise is excessive, or if one of the generator bearings suddenly fails, then the only way to prevent the generator from being rotated may be to separate the generator from the driving power, which is presently done by a shear section incorporated within the drive shaft of the generator. The shear section is typically designed such that the increased load from the torque may cause the shear section to fail and eventually break the shaft resulting in an interruption of power being transmitted from the engine to the electric generator. The shear section design works well for constant speed electric generators that run at one speed only, however, the drive shaft of the generator may be broken and may need to be replaced after each occurrence of a generator malfunction.

Furthermore, with the current demand of variable frequency generators (VFG) to be installed on the latest aircraft, sizing a shear section that can handle variable speed is not possible since a critical force applied to the shear section at which the shear section would break the generator shaft is different for each speed at which the generator shaft may turn. Variable frequency generators as well as high speed rotating electric generators require a mechanical mechanism that can disengage, manually or automatically, the generator from the drive shaft in the event of generator malfunction at any speed of the operating range of the generator. It is necessary that such a disengagement mechanism is re-settable, allows full transmission of power in both directions for power generation and for starting the engine with the generator, fits within the existing hardware and space envelope, has minimum maintenance requirements, and allows periodic testing. Such a disengagement mechanism should further only disengage when it is activated and should not allow unintentional disengagements. Furthermore, a positive means enabling the mechanical mechanism to remain disengaged is necessary to protect stationary components from damaging or being damaged by the high-speed components. If a disconnect device is not employed, the generator may tear itself apart and may be destroyed beyond repair along with damage to the gear box and the aircraft before the plane can make a landing and the problem can be corrected.

Prior art patents, for example, U.S. Pat. No. 3,465,162 and U.S. Pat. No. 4,494,372, are related to auxiliary power systems that can be used to start an aircraft engine. U.S. Pat. No. 3,465,162 teaches improving the efficiency of the starting process of an auxiliary gas turbine by using a generator as a motor. The generator is coupled to the gas turbine through a controlled hydraulic coupler, which provides soft start. Once the gas turbine reaches its appropriate speed, the process is reversed and the generator is used to start the main engine. The coupling and decoupling of the different shafts is done using electro magnetic and hydraulic clutches and/or couplers. Such a hydraulic clutch and/or coupler would not be able to disconnect the generator from the engine at variable speeds in the case of a generator malfunction. U.S. Pat. No. 4,494,372 teaches a multi role primary/auxiliary power system utilizing the integration of mechanical, electrical, and turbo-machinery to provide electrical, mechanical, air conditioning, as well as aircraft engine start functions. Multiple clutches are used to engage and disengage the required drives. Still, none of the disclosed clutches would be able to instantaneously disconnect a generator rotating at variable speeds from the engine in the event of a generator malfunction.

As can be seen, there is a need for a mechanical mechanism that can disengage a variable frequency generator from the driving power in the event of generator malfunction at any speed of the operating range of the generator. Furthermore, there is a need for a mechanical mechanism that is re-settable once the problem for activation is cleared and reusable without having to replace the currently used shaft. Still further, there is a need for a mechanical disengagement mechanism that allows full transmission of power in both directions for power generation and for starting the engine with the generator, fits within the existing hardware and space envelope, has minimum maintenance requirements and allows periodic testing. Still further, there is a need for a disengagement mechanism that only disengages when it is activated, that does not allow unintentional disengagements, and that stays disengaged once activated. There has still further arisen a need for a method for disengaging an electric generator, including variable frequency generators and high speed rotating electric generators, that is connected to an engine from the driving power in the event of a generator malfunction without causing damage to the drive shaft and gearbox.

### SUMMARY OF THE INVENTION

In one aspect of the present invention, a re-settable mechanical disconnect comprises a fixed flange mounted on a first shaft and including a plurality of first teeth, and a retracting flange mounted on a second shaft and including a plurality of second teeth. Each of the first teeth includes a ramp and a flat surface, and the ramp inclines from the flat surface at an angle. Each of the second teeth has the same geometrical dimensions as each of the first teeth and includes a ramp and a flat surface, and the ramp inclines from the flat surface at the angle. The fixed flange engages with the retracting flange such that the ramp of the first teeth mates with the ramp of the second teeth and such that the flat surface of the first teeth mates with the flat surface of the second teeth. The angle is selected such that the retracting flange stays engaged with the fixed flange during power transmission from the first shaft to the second shaft. The angle is selected such that the retracting flange disengages from the fixed flange under the influence of a separating force interrupting the power transmission.

In another aspect of the present invention, a re-settable mechanical disconnect comprises a fixed flange mounted on an output shaft of an engine accessory gearbox and including a plurality of first teeth, a retracting flange mounted on an input shaft of an electric generator and including a plurality of second teeth, and an actuator assembly, wherein the actuator assembly applies an external force in axial direction along the axis to the retracting flange. Each of the first teeth includes a ramp and a flat surface, the ramp inclines from the flat surface at an angle, the output shaft extends axially along an axis, and axial movement of the fixed flange on the output shaft along the axis is disabled. Each of the second teeth has the same geometrical dimensions as each of the first teeth and includes a ramp and a flat surface, the ramp inclines at from the flat surface at the angle, the input shaft extends axially along the axis, and axial movement of the retracting flange on the input shaft along the axis is enabled. The fixed flange engages with the retracting flange such that the ramp of the first teeth mates with the ramp of the second teeth and such that the flat surface of the first teeth mates with the flat surface of the second teeth. The angle is selected such that the retracting flange stays engaged with the fixed flange during rotation of the output shaft. The external force initiates disengagement of the retracting flange and the fixed flange during the rotation of the output shaft, and the angle is selected such that the retracting flange assists the disengagement.

In a further aspect of the present invention, a method for interrupting the power transmission from an engine to an electric generator comprises the steps of: transmitting power from an engine to an electric generator via an engine accessory gear box by utilizing a re-settable mechanical disconnect that includes a fixed flange connected with the engine and engaged with a retracting flange connected with the generator, wherein the fixed flange and the retracting flange include teeth that have a ramp that inclines at an angle; keeping the fixed flange and the retracting flange engaged during the power transmission by selecting the angle such that a frictional force develops on the ramps that engage with each other during the power transmission; applying a separating force to the teeth of a retracting flange, wherein the separating force is larger than the frictional force; and disengaging the retracting flange and the fixed flange and interrupting the power transmission and selecting the angle of the ramps to assist the disengagement.

These and other features, aspects and advantages of the present invention will become better understood with reference to the following drawings, description and claims.

### BRIEF DESCRIPTION OF THE DRAWINGS

FIG. 1 is perspective view of an installed re-settable mechanical disconnect according to an embodiment of the present invention;

FIG. 2 is an exploded view of a re-settable mechanical disconnect according to an embodiment of the present invention;

FIG. 3 is a perspective view of the flanges of a re-settable mechanical disconnect according to an embodiment of the present invention;

FIG. 4 is a simplified side view of a tooth of a retracting flange according to an embodiment of the present invention;

FIG. 5 is a free body diagram of the forces on a tooth of a retracting flange according to an embodiment of the present invention;

FIG. 6 is a simplified side view of a retracting flange engaged with a fixed flange according to an embodiment of the present invention;

FIG. 7 is a perspective view of an actuator assembly of a re-settable mechanical disconnect according to an embodiment of the present invention;

FIG. 8 is a flow chart schematically representing a normal operation mode of a re-settable mechanical disconnect according to an embodiment of the present invention;

FIG. 9 is a flow chart schematically representing a casualty operation mode of a re-settable mechanical disconnect according to an embodiment of the present invention;

FIG. 10 is a flow chart schematically representing a lockout operation mode of a re-settable mechanical disconnect according to an embodiment of the present invention; and

FIG. 11 is a flow chart schematically representing an automatic activation process of a re-settable mechanical disconnect according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides a high speed/high power re-settable mechanical disconnect for rotating shafts and a method for re-settably disengaging an electric generator connected to an engine from the driving power in the event of a generator malfunction. One embodiment of the present invention provides a mechanical disconnect between an aircraft engine and an electric generator that enables disconnection of power being transmitted from the engine to the generator in the case of generator malfunction at any operational speed of the generator. The mechanical disconnect can be activated in the case of a generator failure and can be re-set and reused once the cause for activation is cleared. An embodiment of the present invention provides a re-settable mechanical disconnect that is suitable for, but not limited to, disengaging a variable frequency generator or a high speed rotating electric generator. An embodiment of the present invention provides a high speed/high power re-settable mechanical disconnect that is suitable for, but not limited to, applications, such as aircraft engines and aircraft auxiliary power systems, in the aircraft and aerospace industries.

In one embodiment the present invention provides a mechanical disconnect positioned between an engine and an electric generator that is able to interrupt the power transmission from the engine to the electric generator The ability to disconnect a generator may allow an aircraft to maintain its operation while stopping the generator from turning in the event of failure and may protect the engine, the engine accessory gearbox, and the electric generator in the event of generator failure.

In contrast with conventional devices that cause damage to the shaft driving the generator and that operate only at constant speeds, the mechanical disconnect of the present invention may be re-settable without generator or generator shaft removal and may be reusable by enabling interruption in the transmission of power to the generator without causing damage to either shaft or component. Using the mechanical disconnect of the present invention there is no need to replace the shafts used in the event of generator failure. This is a contrast to the prior art shear design where the drive shaft is broken in the case of a generator failure.

In further contrast with prior art devices that do not allow for interruption of power between a engine and a generator at variable operation speeds of a generator in the event of generator failure, the mechanical disconnect of the present invention may be compact, lightweight, able to transmit required power over the necessary speed ranges both from the engine to the generator and from the generator to the engine when starting the engine from rest, and able to disengage a variable frequency generator from the driving power in the event of generator malfunction at any speed of the operating range of the generator. The mechanical disconnect of the present invention may fit within the existing hardware and space envelope of an aircraft engine, and, more specifically, may interface between the main engine accessory gear box of an aircraft and electric generator once properly adapted. The mechanical disconnect of the present invention may have minimum maintenance requirements and may allow periodic testing. Still further, the mechanical disconnect of the present invention may only disengage when activated and may not allow unintentional disengagements. A positive means for remaining disengaged after activation due to generator failure may be incorporated into the mechanical disconnect as in one embodiment of the present invention to protect stationary components from damaging or being damaged by high-speed components.

In additional contrast to prior art devices that have a shear design and varied disconnect design incorporated in the drive shaft, the design of the mechanical disconnect of the present invention incorporates two flanges, fixed and retracting, and uses several sloped helical inclines, known as teeth, that mate together in a way that provides for positive contact and power transmission. The ramped teeth may allow power to be transmitted safely at the required speeds and may aid in separating one another allowing for the generator to stop while the operation of the engine is maintained. The flanges, fixed and retracting, may be modified to a variety of acceptable torque-to-separating force ratios by, for example, reducing the angle of the incline slopes of the ramped teeth, thus, reducing or increasing the tooth height, reducing the number of teeth, the thickness of the flanges, and the diameter of the flanges. This may allow the mechanical disconnect of the present invention to be small enough to deliver the appropriate force, but yet be large enough to cause the disengagement to occur instantaneously.

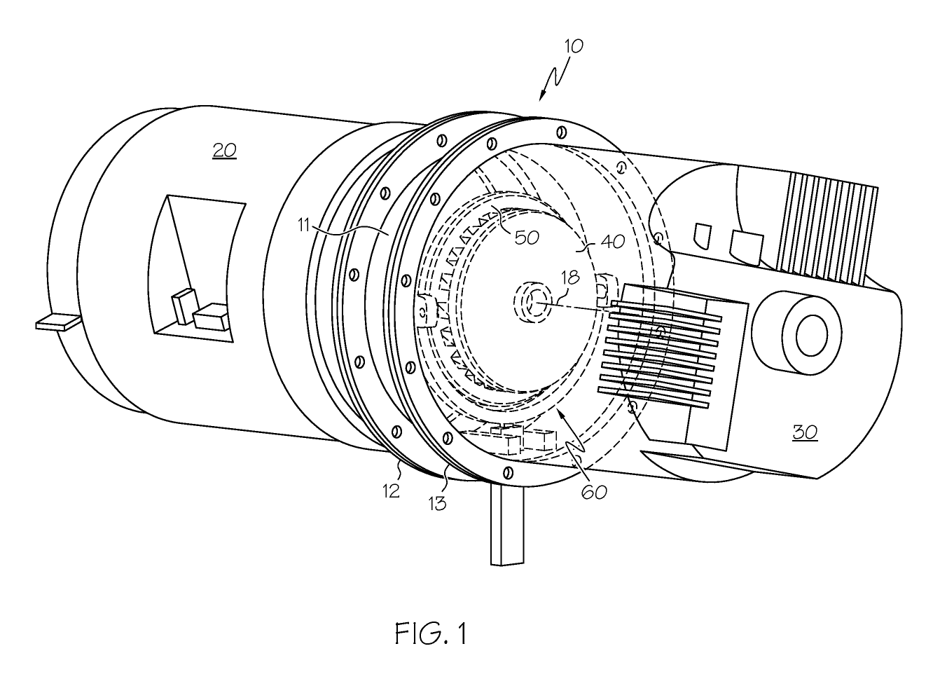

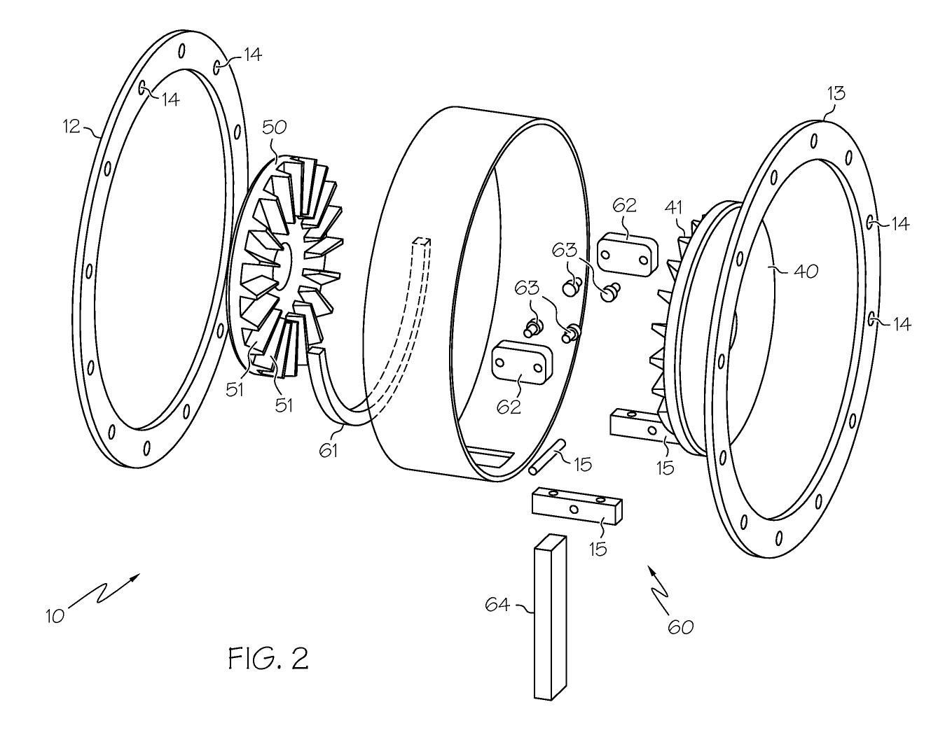

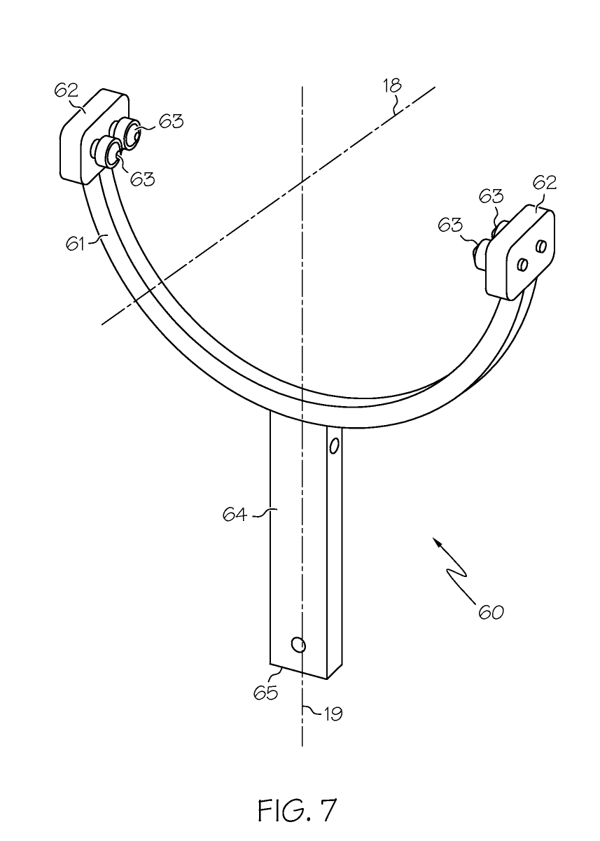

Referring now to FIG. 1, a perspective view of an installed re-settable mechanical disconnect 10 is illustrated according to an embodiment of the present invention. The re-settable mechanical disconnect 10 may be installed between an engine accessory gearbox (AGB) 20 and an electric generator 30. The re-settable mechanical disconnect 10 may include a retracting flange 40, a fixed flange 50, and an actuator assembly 60, as is also shown in an exploded view in FIG. 2. A housing ring 11 may surround and provide a space envelope for the re-settable mechanical disconnect 10 and may support the actuating assembly 60 (also shown in FIGS. 2 and 7). The housing ring 11 may include a cutout 16 for receiving the actuator assembly 60 (as illustrated in FIG. 2). A first mounting ring 12 may be connected with the housing ring 11 and a second mounting ring 13 may be connected with the housing ring 11 opposite from the first mounting ring 12. For example, the housing ring 11 may be inserted into the first mounting ring 12 and the second mounting ring 13. Each of the first mounting ring 12 and the second mounting ring 13 may include a plurality of apertures 14 that may be used to attach the first mounting ring 12 to the engine accessory gearbox (AGB) 20 and the second mounting ring 13 to the electric generator 30.

The engine accessory gearbox (AGB) 20 may include a splined output shaft (not shown). The electric generator 30 may include a splined input shaft (not shown). In the following the output shaft of the engine accessory gearbox (AGB) 20 may be called “engine shaft” and the input shaft of the electric generator 30 may be called “generator shaft”. The fixed flange 50 may be mechanically fixed on the engine shaft while the retracting flange 40 may be allowed to slide back and forth in an axial direction along an axis 18 on the generator shaft. The fixed flange 50 may include a splined cutout 52 (shown in FIG. 3) suitable for mating with the splined engine shaft and enabling the fixed flange to rotate at the same speed and in the same direction as the engine shaft. The fixed flange 50 may further be mechanically disabled to move along the engine shaft in the direction of the axis 18. The retracting flange 40 may include splined cutouts 42 (shown in FIG. 3) suitable for mating with the splined generator shaft and enabling the retracting flange 40 to rotate at the same speed and in the same direction as the generator shaft. The re-settable mechanical disconnect 10 may provide engagement or disengagement of the engine shaft (not shown) of the engine accessory gearbox (AGB) 20 with the generator shaft (not shown) of the electric generator 30.

If engaged, as shown in FIG. 1, torque and, therefore, power may be transmitted from the engine (not shown) via the engine accessory gearbox (AGB) 20 to the electric generator 30 to produce electricity, for example, for an aircraft. Conversely, power may be transmitted from the electric generator 30 to the engine via the engine accessory gearbox (AGB) 20 when starting the engine from rest. An actuator assembly 60 may be used to initiate disengagement of the electric generator 30 from the engine accessory gearbox (AGB) 20. When disengaged or disconnected, no power may be transmitted to the electric generator 30 from the engine accessory gearbox (AGB) 20.

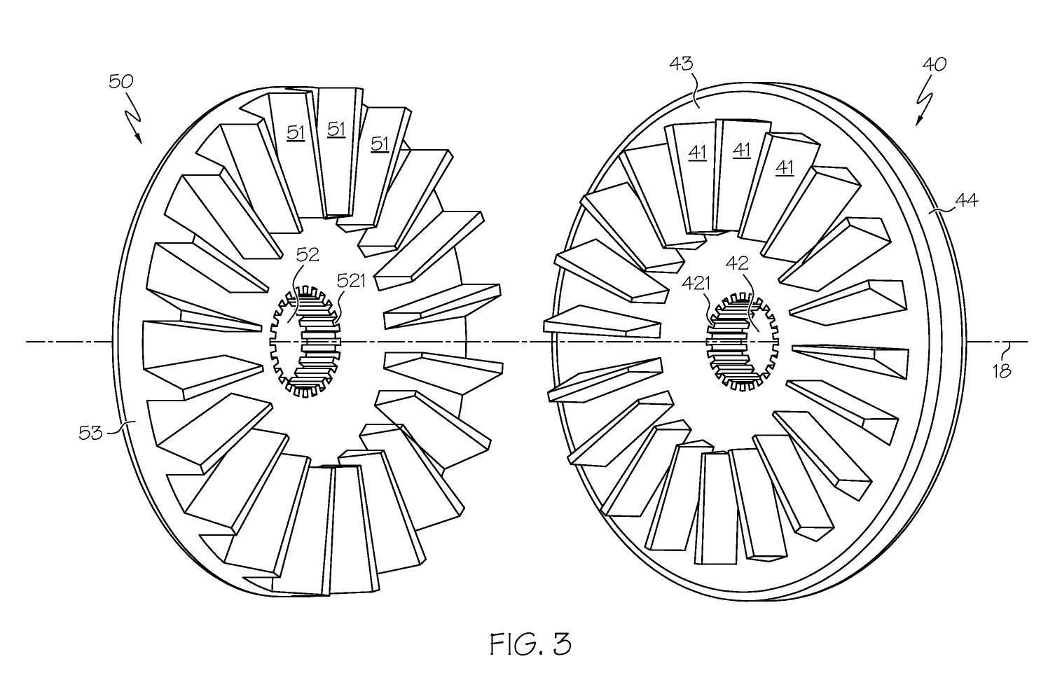

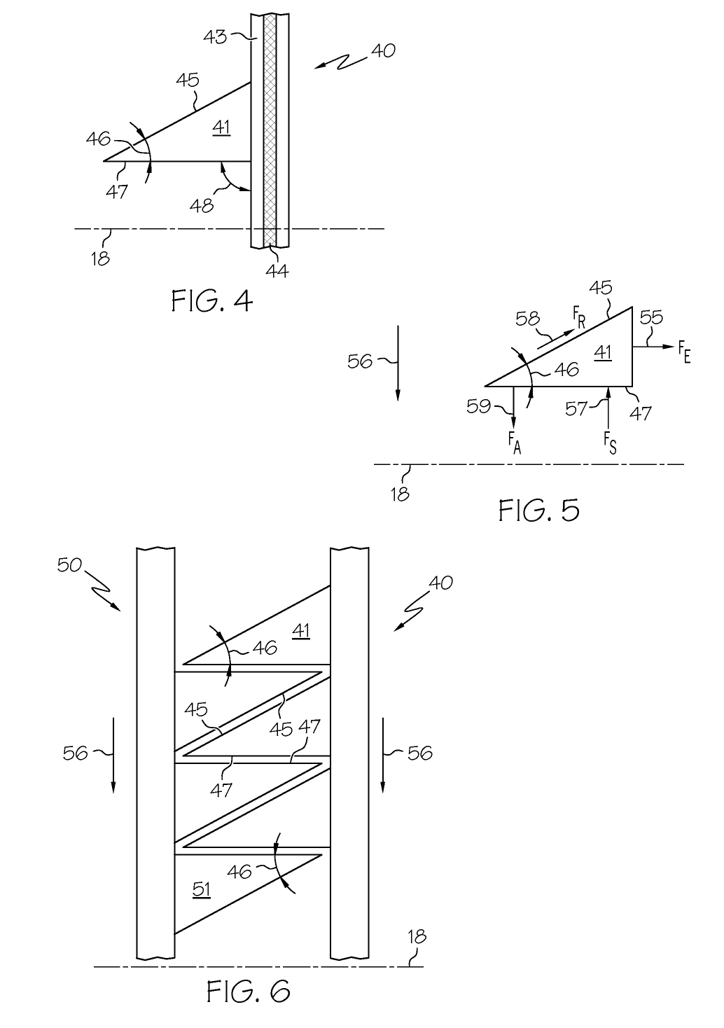

The engine accessory gearbox (AGB) 20 may be, but is not limited to, part of an engine of an aircraft. The electric generator 30 may be a variable frequency generator or a constant speed generator. The electric generator 30 may be, but is not limited to, a high-speed rotating aircraft electric generator. Referring now to FIG. 3, a perspective view of the flanges 40 and 50 of a re-settable mechanical disconnect 10 is illustrated according to an embodiment of the present invention. The retracting flange 40 and the fixed flange 50 may be designed to be the heart of the re-settable mechanical disconnect 10 (illustrated in FIGS. 1 and 2). The retracting flange 40 and the fixed flange 50, each may be a round disk 43 and 53, respectively. The retracting flange 40 may include a plurality of teeth 41 and all teeth 41 may be positioned on one side of the disk 43 only. The fixed flange 50 may include a plurality of teeth 51 and all teeth 51 may be positioned on one side of disk 53 only. The teeth 41 and the teeth 51 may have an identical geometry and may be arranged in a circle on the disk 43 and 53, respectively, as shown in FIG. 3. One tooth 41 is illustrated in FIG. 4 as an example. The tooth 41 may include a ramp 45 and a flat surface 47. The ramp 45 may be an inclined surface that inclines from the flat surface 47 at an angle 46. The flat surface may extend from the disk 43 at a right angle 48. The ramp 45 may be a mating face. The flat surface 47 may also be a mating face.

The retracting flange 40 and the fixed flange 50, each may further include a splined cutout 42 and 52, respectively, as shown in FIG. 3. The splined cutouts 42 and 52 may include spline teeth, 421 and 521, respectively, that may mate with spline teeth of the generator shaft and the engine shaft, respectively. Enabled by the spline teeth 421, the retracting flange 40 may rotate at the same speed and in the same direction as the generator shaft of the generator 30. Enabled by the spline teeth 521, the fixed flange 50 may rotate at the same speed and in the same direction as the engine shaft of the AGB 20. The splined cutouts 42 and 52 may be centered at the center of each disk 43 and 53, respectively. The size of the cutout 42 may be chosen such that the retracting flange 40 may fit on the generator shaft (not shown) of the generator 30 (shown in FIG. 1) such that power may be transmitted either from the retracting flange 40 to the generator 30 or from the generator 30 to the retracting flange 40 and such that the retracting flange 40 is allowed to slide back and forth along axis 18 on the generator shaft. The size of the cutout 52 may be chosen such that the fixed flange 50 may fit on the engine shaft (not shown) of the engine AGB 20 (as shown in FIG. 1) such that power may be transmitted either from the fixed flange 50 to the engine AGB 20 or from the engine AGB 20 to the fixed flange 50 and such that the fixed flange may be mechanically fixed on the engine shaft. Thus, the fixed flange 50 may not be able to slide in axial direction along axis 18 on the engine shaft while the retracting flange 40 may be allowed to slide back and forth in axial direction along axis 18 on the generator shaft.

The retracting flange 40 may differ from the fixed flange 50 by including an outer lip 44 positioned at the circumference of the disk 43, as shown in FIG. 3. The outer lip 44 may be, for example, about 0.5 inches wide. The outer lip 44 may be the location where the actuator assembly 60 (as shown in FIGS. 1, 2, and 7) applies an external axial force F_{E} 55 (shown in FIG. 5) to move the retracting flange 40 axially along the axis 18 relative to the fixed flange 50 allowing engagement and disengagement of the retracting flange 40 and the fixed flange 50 while the flanges 40 and 50 are spinning at any speed in the operating range of the generator 30. The flanges 40 and 50 may be manufactured, for example, from steel of appropriate strength.

When the retracting flange 40 is engaged with the fixed flange 50, the teeth 41 of the retracting flange 40 may mate with the teeth 51 of the fixed flange 50, as shown in FIG. 6. As illustrated, the ramp 45 of the tooth 51 may mate with the ramp 45 of the tooth 41 and the flat surface 47 of the tooth 51 may mate with the flat surface 47 of the tooth 41. Consequently, the mating faces 45 and 47 of the retracting flange 40 may fit onto the mating faces 45 and 47 of the fixed flange 50. When the retracting flange 40 is engaged with the fixed flange 50, power may be transmitted form the fixed flange 50 to the retracting flange 40 or from the retracting flange 40 to the fixed flange 50 utilizing the faces 45 and 47, respectively. The flat surface 47 may enable the retracting flange 40 to spin the fixed flange 50, for example, when the generator 30 is starting the engine via AGB 20. Since the flat surface 47 may be oriented at a 90-degree angle 48, the retracting flange 40 may fully engage with the fixed flange 50 without separation during the start up of the engine. As can be seen in FIG. 6, when the retracting flange 40 is rotated in direction 56, the flat surface 47 of the tooth 41 may engage with the flat surface 47 of the tooth 51 to spin the fixed flange 50 and, consequently, to transmit power from the generator shaft of the generator 30 to the engine shaft of the AGB 20. When the fixed flange 50 is rotated in direction 56, the ramp 45 of the tooth 51 may mate with the ramp 45 of tooth 41 to spin the retracting flange 40 and, consequently, to transmit power from the engine shaft of the AGB 20 to the generator shaft of the generator 30. The retracting flange 40 may disengage by sliding axially away along axis 18 from the fixed flange 50 by taking advantage of a separating force F_{A} 59 (shown in FIG. 6) developed by the ramp 45 of the teeth 41 and 51.

Referring now to FIG. 5, a free body diagram of the forces on a tooth 41 of a retracting flange 40 is illustrated according to an embodiment of the present invention. Each ramped tooth 41 and 51 may harness the mechanical advantage from rotation to aid the separation of the retracting flange 40 from the fixed flange 50. The major forces that may affect each tooth 41 and 51 may include a static frictional force F_{S} 57 exerted by the splined generator shaft of the generator 30 on the retracting flange 40 or exerted by the splined engine shaft on the fixed flange 50, respectively, a frictional force F_{R} 58 exerted by the rotation of the fixed flange 50 on the teeth 41 and 51, and a separating force F_{A} 59. The frictional force F_{R} 58 may be caused when the ramps 45 of the tooth 41 and the tooth 51 slide past each other during rotation. The separating force F_{A} 59 may be the force required to separate the fixed flange 50 and the retracting flange 40 once they are engaged.

As shown in FIG. 4, the ramp 45 of each tooth 41 and 51 may incline at an angle 46. The angle 46 may be calculated and selected such that the frictional force F_{R} 58 developed on the ramps 46 of the teeth 41 and 51 is large enough to keep the fixed flange 50 and the retracting flange 40 engaged during normal operation where the generator 30 is driven by the engine via engine AGB 20. Consequently, no additional axial force in direction of axis 18 may be needed to keep the fixed flange 50 and the retracting flange 40 engaged.

The teeth 41 and 51 may transmit power from the fixed flange 50 to the retracting flange 40 by utilizing the static frictional force F_{S} 57 and the frictional force F_{R} 58 that affects the ramps 45 of each tooth 41 and 51. The retracting flange 40 may disengage from the fixed flange 50 by sliding axially away along axis 18 from the fixed flange 50 by taking advantage of the separating force F_{A} 59. When the combined force of the static frictional force F_{S} 57 and the frictional force F_{R} 58 is greater than the separating force F_{A} 59, the fixed flange 50 and the retracting flange 40 may remain engaged and power may be transmitted from the engine via the AGB 20 to the generator 30. When the generator starts spinning at an exceptional high speed, for example, when the generator bearings start to seize, or when an external axial force F_{E} 55 is applied to the retracting flange that may initiate moving the retracting flange 40 along axis 18 away from the fixed flange 50, for example, by using the actuator assembly 60 (FIG. 7), the separating force F_{A} 59 may be higher than the combined force of the static frictional force F_{S} 57 and the frictional force F_{R} 58 and the retracting flange 40 may disengage from the fixed flange 50.

Once an impulse force (external axial force F_{E} 55 along axis 18 or abnormal exceptional fast rotation of the retracting flange 40) causes the retracting flange 40 to start moving away from the fixed flange 50, a static friction coefficient of the combined frictional forces F_{S} 57 and F_{R} 58 may become a kinetic friction coefficient, which value decreases dramatically, and the ramps 45 on the teeth 41 and 51 of the retracting flange 40 and the fixed flange 50, respectively, may disengage. It may be essential for the present invention that a critical angle 46 may be found, in which the combined force of the static frictional force F_{S} 57 and the frictional force F_{R} 58 may be enough to hold the flanges 40 and 50 together with a minimum safety factor during normal operation (power transmission from the AGB 20, and therefore the fixed flange 50, to the generator 30, and therefore the retracting flange 40) while minimizing the amount of external force F_{E} 55 needed to cause separation of the retracting flange 40 from the fixed flange 50.

Referring now to FIG. 7, a perspective view of an actuator assembly 60 of a re-settable mechanical disconnect 10 is illustrated according to one embodiment of the present invention. The actuator assembly 60 may include a wishbone 61, two actuator pads 62, four guide rollers 63, and an actuator arm 64. The wishbone 61 may be in a fixed connection with the actuator arm 64. Each of the actuator pads 62 may have two of the guide rollers 63 attached. The actuator pads 62 may be in a fixed connection with the wishbone, such that the guide rollers 63 of each actuator pad 62 face each other. The actuator arm 64 may be installed by inserting into the cutout 16 of the housing ring 11 (as shown in FIGS. 1 and 2). Three actuator arm support mounts 15 may be attached to the housing ring 11 and may assist supporting the actuator assembly 60. As can be seen in detail in FIG. 2, the actuator support mounts 15 may be attached to the inside of the housing ring 11 surrounding the cutout 16 at three sides providing guidance and support for the actuator arm 64. The wishbone 61, the actuator pads 62, and the actuator arm 64 may be manufactured out of high tensile stainless steel, for example A286, for its strength and corrosion properties.

The actuator assembly 60 may be attached to the actuator arm 64 and may provide the mechanical means to slide the retracting flange 40 (FIGS. 1-3) axially along the generator shaft of the generator 30 to assist disengagement (in the case of a generator 30 failure) or engagement (while re-setting the RMD 10). The guide rollers 63 may sandwich the outer lip 44 of the retracting flange 40 (FIG. 3) and may be loaded only when the re-settable mechanical disconnect 10 is in the process of disengagement or engagement (re-setting). The guide rollers 63 may not be used to hold the retracting flange 40 engaged with the fixed flange 50 during normal operation since the frictional force 58 (as shown in FIG. 5) may be sufficient for keeping the retracting flange 40 engaged with the fixed flange 50 during normal operation. Thereby, loss of energy due to contact of the guide rollers 63 with the retracting flange 40 and the wear of the guide rollers 63 may be minimized. When activated, the guide rollers 63 may provide an external “knock-out” force in axial direction along axis 18 (shown in FIGS. 1, 3, and 7) that gives the retracting flange 40 a “punch”, which may enable overcoming the static friction force between the external spline teeth of the generator shaft and the internal spline teeth 421 (shown in FIG. 3) of the splined cutout 42 of the retracting flange 40. After separation, the retracting flange 40 may rest away from the fixed flange 50, thus, disengaging the power transmission from the engine shaft, and therefore the fixed flange 50, to the generator shaft, and therefore the retracting flange 40.

The actuator assembly 60 may be designed to use hydraulic or electric power input to provide bi-directional axial motion along axis 18 (also shown in FIG. 1) of the retracting flange 40. The hydraulic or electric power input may further provide tangential movement in the direction of axis 19 for the actuator assembly 60. The hydraulic or electric power input may be applied to the actuator arm 64 at the end 65 opposite from the wishbone 61. The movement of the actuator assembly 60 and, thus, the retracting flange 40, may be controlled for example, by a hydraulic cylinder/piston actuator or a dual acting electric solenoid plunger (both not illustrated). The hydraulic piston or the electric solenoid plunger may connect to the end 65 of the actuator arm 64.

The hydraulic cylinder/piston actuator may use the potential energy from a hydraulic accumulator and generator oil pump through a four-way valve to port fluid to engage the flanges for starting. Once started, the hydraulic pressure is no longer needed, and the retracting flange 40 and the fixed flange 50 may be able to stay together on friction alone. The four-way valve may be placed in mid-position to allow the cylinder to vent pressure to the oil reservoir. The four way valve may be positioned in the opposite direction causing the retracting flange 40 to separate and may remain in this position to lock the retracting flange 40 in the disengage position.

A dual acting electric solenoid plunger could alternatively be used to engage and disengage the retracting flange 40 and the fixed flange 50. The dual acting electric solenoid plunger may be used to initially engage the flanges 40 and 50 while starting. During normal operation the dual acting electric solenoid plunger may be de-energized. In the case of a malfunction of the generator 30, the dual acting electric solenoid plunger may be energized in the opposite direction to disengage the flanges and may remain energized to maintain the position of the retracting flange 40 away from the rotating fixed flange 50.

The application of either of these power inputs may allow the engaging and disengaging of the retracting flange 40 and the fixed flange 50 to be performed by one person such as a pilot, for example, from the cockpit of an aircraft. A remote position sensor and dash mounted indicator lights may be installed to assist the pilot in determining the status of the re-settable mechanical disconnect 10.

Referring now to FIG. 8, a flow chart schematically representing a normal operation mode 70 of a re-settable mechanical disconnect (RMD) 10 is illustrated according to an embodiment of the present invention. The normal operation mode 70 of the re-settable mechanical disconnect 10 (as shown in FIGS. 1 and 2) may involve a step 71 where the engine may be stopped and the fixed flange 50 and the retracting flange 40 of the RMD 10 may be engaged. If the RMD was disengaged it may be manually engaged in step 71. A step 72 may involve starting the engine with the generator 30 via the engaged RMD 10 and the engine accessory gearbox (AGB) 20.

In flight, the engine may power the generator 30 via the engine AGB 20 and the engaged RMD 10, in a step 73. The fixed flange 50 and the retracting flange 40 of the RMD 10 may remain in engaged position throughout the flight. In a following step 74, the aircraft lands and the engine may be turned off, but the fixed flange 50 and the retracting flange 40 of the RMD 10 may remain in engaged position. The fixed flange 50 and the retracting flange 40 of the RMD 10 may remain in engaged position until the next start up of the engine.

Referring now to FIG. 9, a flow chart schematically representing a casualty operation mode 80 of a re-settable mechanical disconnect (RMD) 10 is illustrated according to an embodiment of the present invention. The casualty operation mode 80 of the RMD 10 may include a step 81, which may involve an aircraft in flight, the fixed flange 50 and the retracting flange 40 of the RMD 10 in engaged position, and a generator 30 rotating. In a following step 82 a condition may arise, which requires the generator to be stopped.

The pilot of the aircraft may receive indication of the failure condition and may actuate a switch, which may activate the actuator assembly and may cause the retracting flange 40 to disengage from the fixed flange 50 of the RMD 10, in step 83. The pilot may send an electric signal to activate a trip mechanism that controls the actuator assembly 60, such as a hydraulic cylinder/piston actuator or a dual acting electric solenoid plunger, remotely from within the cockpit. The trip mechanism may move the actuator assembly 60 which may cause the retracting flange 40 to disengage from the fixed flange 50, which in turn may stop the rotation of the generator 30.

A following step 84 may involve that the aircraft continues the flight and that the retracting flange 40 stays disengaged from the fixed flange 50 for the remainder of the flight.

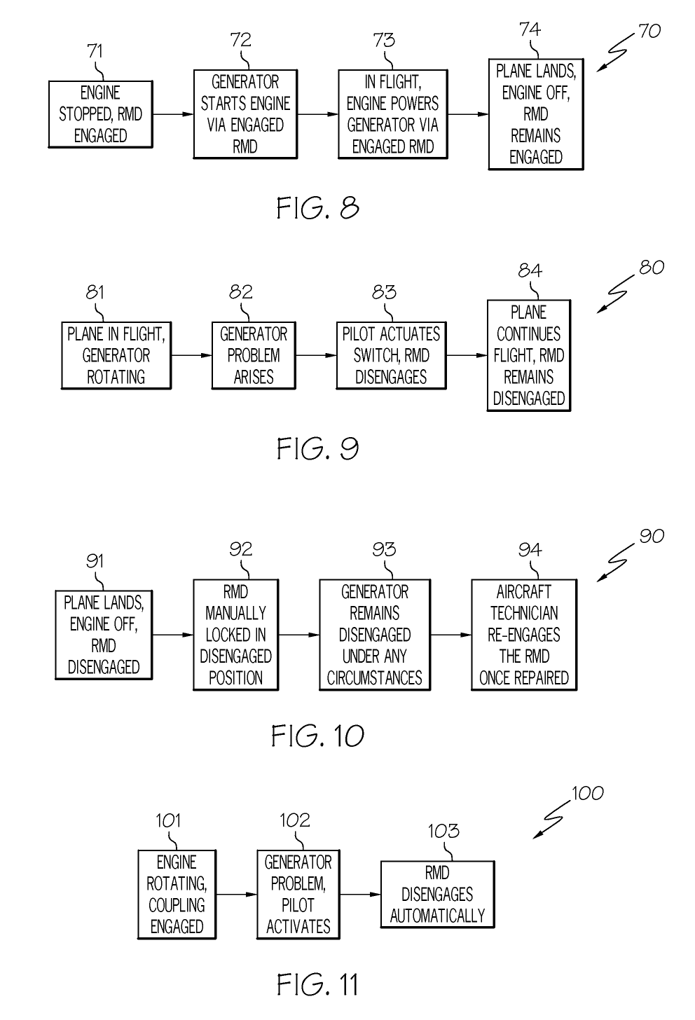

Referring now to FIG. 10, a flow chart schematically representing a lockout operation mode 90 of a re-settable mechanical disconnect (RMD) 10 is illustrated according to an embodiment of the present invention. The lockout operation mode of the RMD 10 may follow the casualty operation mode 80 shown in FIG. 9 and may involve a step 91 where the aircraft lands, the engine may be turned off, and the retracting flange 40 is disengaged from the fixed flange 50 of the RMD 10. In step 92, a manual mechanical lockout may be enabled to prevent accidental re-engagement of the retracting flange 40 with the fixed flange 50 of the RMD 10.

The generator 30 may remain disengaged under any circumstances in a following step 93. The manual lockout may allow the aircraft to have additional flights until the next maintenance. In a step 94, an aircraft technician may investigate the fault for the activation of the disengagement and may repair the generator or otherwise solve the problem that caused the activation of the disengagement of the retracting flange 40 from the fixed flange 50 and may manually re-engage the retracting flange 40 and the fixed flange 50. Therefore, the RMD 10 is re-settable.

Referring now to FIG. 11, a flow chart schematically representing an automatic activation process 100 of a re-settable mechanical disconnect (RMD) 10 is illustrated according to an embodiment of the present invention. The activation process may involve a step 101, which may include that the engine rotates and that the fixed flange 50 and the retracting flange 40 are engaged. The generator 30 may be operating normally supplying required power. In step 102, a problem develops in the generator 30 that requires the generator 30 to stop, for example, excessive rotation speed or sudden jamming. A following step 103 may involve automatically disengaging the retracting flange 40 from the fixed flange 50 due to development of an axial force that exceeds the frictional force typically keeping the fixed flange 50 and the retracting flange 40 engaged.

It should be understood, of course, that the foregoing relates to exemplary embodiments of the invention and that modifications may be made without departing from the spirit and scope of the invention as set forth in the following claims.

We claim:

1. A re-settable mechanical disconnect, comprising:
a fixed flange mounted on a first shaft and including a plurality of first teeth, wherein each of said first teeth includes a ramp and a flat surface, wherein said ramp inclines from said flat surface at an angle; and
a retracting flange mounted on a second shaft and including a plurality of second teeth, wherein each of said second teeth has the same geometrical dimensions as each of said first teeth and includes a ramp and a flat surface, wherein said ramp inclines from said flat surface at said angle;
wherein said fixed flange engages with said retracting flange such that said ramp of said first teeth mates with said ramp of said second teeth and such that said flat surface of said first teeth mates with said flat surface of said second teeth;
wherein said angle is selected such that said retracting flange stays engaged with said fixed flange during power transmission from said first shaft to said second shaft; and
wherein said angle is selected such that said retracting flange disengages from said fixed flange under the influence of a separating force interrupting said power transmission.

2. The re-settable mechanical disconnect of claim 1, wherein said first shaft extends axially along an axis and wherein axial movement of said fixed flange on said first shaft along said axis is disabled.

3. The re-settable mechanical disconnect of claim 1, wherein said second shaft extends axially along said axis and wherein axial movement of said retracting flange on said second shaft along said axis is enabled.

4. The re-settable mechanical disconnect of claim 1, wherein said fixed flange rotates at the same speed and in the same direction as said first shaft and wherein said retracting flange rotates at the same speed and in the same direction as said second shaft.

5. The re-settable mechanical disconnect of claim 1, wherein said second shaft is an input shaft of an electric generator.

6. The re-settable mechanical disconnect of claim 1, wherein said first shaft is an output shaft of an engine accessory gearbox.

7. The re-settable mechanical disconnect of claim 1, wherein said retracting flange and said fixed flange both comprise a round disk including a splined cutout, wherein said splined cutouts mate with said first and said second shaft that are splined, wherein a static frictional force is exerted by the splined shafts on said fixed flange and on said retracting flange.

8. The re-settable mechanical disconnect of claim 7, wherein said angle is selected such that a frictional force developed on said ramp of said first tooth and on said ramp of said second tooth during rotation of said first shaft in combination with said static frictional force is larger than said separating force and wherein said retracting flange stays engaged with said fixed flange.

9. The re-settable mechanical disconnect of claim 7, wherein said separating force is larger than said combination of said static frictional force and said frictional force between said ramp of said first tooth and said ramp of said second tooth and wherein said retracting flange disengages from said fixed flange.

10. The re-settable mechanical disconnect of claim 1, wherein said flat surface of said second tooth engages with said flat surface of said first tooth during rotation of said second shaft enabling power transmission from said second shaft to said first shaft.

11. The re-settable mechanical disconnect of claim 1, wherein said ramp of said first tooth engages with said ramp of said second tooth during rotation of said first shaft enabling said power transmission from said first shaft to said second shaft.

12. A re-settable mechanical disconnect, comprising:
a fixed flange mounted on an output shaft of an engine accessory gearbox and including a plurality of first teeth, wherein each of said first teeth includes a ramp and a flat surface, wherein said ramp inclines from said flat surface at an angle, wherein said output shaft extends axially along an axis, and wherein axial movement of said fixed flange on said output shaft along said axis is disabled;
a retracting flange mounted on an input shaft of an electric generator and including a plurality of second teeth, wherein each of said second teeth has the same geometrical dimensions as each of said first teeth and includes a ramp and a flat surface, wherein said ramp inclines at from said flat surface at said angle, wherein said input shaft extends axially along said axis and wherein axial movement of said retracting flange on said input shaft along said axis is enabled, and wherein said fixed flange engages with said retracting flange such that said ramp of said first teeth mates with said ramp of said second teeth and such that said flat surface of said first teeth mates with said flat surface of said second teeth, and wherein said angle is selected such that said retracting flange stays engaged with said fixed flange during rotation of said output shaft; and
an actuator assembly, wherein said actuator assembly applies an external force in axial direction along said axis to said retracting flange, wherein said external force initiates disengagement of said retracting flange and said fixed flange during said rotation of said output shaft, and wherein said angle is selected such that said retracting flange assists said disengagement.

13. The re-settable mechanical disconnect of claim 12, wherein said actuator assembly includes an actuator arm and a wishbone that includes guide rollers, wherein said actuator arm is movable along an axis towards and away from said retracting flange, and wherein said guide rollers make contact with said retracting flange and moves said retracting flange along said axis.

14. The re-settable mechanical disconnect of claim 12, wherein said angle is selected such that a frictional force developed on said ramp of said first tooth and on said ramp of said second tooth during rotation of said output shaft of said engine accessory gearbox in combination with a static frictional force exerted by said output shaft on said fixed flange is large enough to keep said retracting flange and said fixed flange engaged during said rotation of said output shaft.

15. The re-settable mechanical disconnect of claim 14, wherein said external force is larger than said combination of said frictional force and said static frictional force.

16. The re-settable mechanical disconnect of claim 12, wherein said actuator assembly moves said retracting flange along said axis towards said fixed flange re-engaging said retracting flange with said fixed flange.

17. A method for interrupting the power transmission from an engine to an electric generator, comprising the steps of:
transmitting power from an engine to an electric generator via an engine accessory gear box by utilizing a re-settable mechanical disconnect that includes a fixed flange connected with said engine and engaged with a retracting flange connected with said generator, wherein said fixed flange and said retracting flange include teeth that have a ramp that inclines at an angle;
keeping said fixed flange and said retracting flange engaged during said power transmission by selecting said angle such that a frictional force develops on said ramps that engage with each other during said power transmission;
applying a separating force to said teeth of a retracting flange, wherein said separating force is larger than said frictional force; and
disengaging said retracting flange and said fixed flange and interrupting said power transmission and selecting said angle of said ramps to assist said disengagement.

18. The method of claim 17, further comprising the step of maintaining disengagement of said retracting flange from said fixed flange while continuing operation of said engine.

19. The method of claim 17, further comprising the steps of:
receiving a failure signal from said generator;
remotely activating a trip mechanism;
moving an actuator assembly with said trip mechanism to make contact with said retracting flange; and
applying an external axial force to said retracting flange with said actuator assembly.

20. The method of claim 17, further comprising the steps of:
stopping operation of said engine; and
re-engaging said fixed flange and said retracting flange.
